(19) United States
(12) Patent Application Publication
(10) Pub. No.: US 2007/0083783 A1
(43) Pub. Date: Apr. 12, 2007

(54) Reducing power consumption at a cache

(76) Inventors: Toru Ishihara, Fukuoka (JP); Farzan Fallah, San Jose, CA (US)

Correspondence Address: BAKER BOTTS L.L.P., 2001 ROSS AVENUE, SUITE 600, DALLAS, TX, 75201-2980, US

(21) Appl. No.: 11/198,693

(22) Filed: Aug. 5, 2005

(51) Int. Cl. G06F 1/32

(52) U.S. Cl. 713/320

(57) ABSTRACT

In one embodiment, a method for reducing power consumption at a cache includes determining a code placement according to which code is writable to a memory separate from a cache. The code placement reduces occurrences of inter cache-line sequential flows when the code is loaded from the memory to the cache. The method also includes compiling the code according to the code placement and writing the code to the memory for subsequent loading from the memory to the cache according to the code placement to reduce power consumption at the cache. In another embodiment, the method also includes determining a nonuniform architecture for the cache providing an optimum number of cache ways for each cache set in the cache. The nonuniform architecture allows cache sets in the cache to have associativity values that differ from each other. The method also includes implementing the nonuniform architecture in the cache to further reduce power consumption at the cache.

### TECHNICAL FIELD OF THE INVENTION

This invention relates in general to memory systems and more particularly to reducing power consumption at a cache.

### BACKGROUND OF THE INVENTION

A cache on a processor typically consumes a substantial amount of power. As an example, an instruction cache on an ARM920T processor accounts for approximately 25% of power consumption by the processor. As another example, an instruction cache on a StrongARM SA-110 processor, which targets low-power applications, accounts for approximately 27% of power consumption by the processor.

### SUMMARY OF THE INVENTION

Particular embodiments of the present invention may reduce or eliminate problems and disadvantages associated with previous memory systems.

In one embodiment, a method for reducing power consumption at a cache includes determining a code placement according to which code is writable to a memory separate from a cache. The code placement reduces occurrences of inter cache-line sequential flows when the code is loaded from the memory to the cache. The method also includes compiling the code according to the code placement and writing the code to the memory for subsequent loading from the memory to the cache according to the code placement to reduce power consumption at the cache.

In another embodiment, the method also includes determining a nonuniform architecture for the cache providing an optimum number of cache ways for each cache set in the cache. The nonuniform architecture allows cache sets in the cache to have associativity values that differ from each other. The method also includes implementing the nonuniform architecture in the cache to further reduce power consumption at the cache.

Particular embodiments of the present invention may provide one or more technical advantages. As an example and not by way of limitation, particular embodiments may reduce power consumption at a cache. Particular embodiments provide a nonuniform cache architecture for reducing power consumption at a cache. Particular embodiments facilitate code placement for reducing tag lookups, way lookups, or both in a cache to reduce power consumption at the cache. Particular embodiments facilitate simultaneous optimization of cache architecture and code placement to reduce cache way or tag accesses and cache misses. Particular embodiments may provide all, some, or none of these technical advantages. Particular embodiments may provide one or more other technical advantages, one or more of which may be readily apparent to those skilled in the art from the figures, descriptions, and claims herein.

### BRIEF DESCRIPTION OF THE DRAWINGS

To provide a more complete understanding of the present invention and features and advantages thereof, reference is made to the following description, taken in conjunction with the accompanying drawings, in which:

FIG. 1 illustrates an example nonuniform cache architecture for reducing power consumption at a cache; and

FIGS. 2A and 2B illustrate example code placement for reducing power consumption at a cache.

### DESCRIPTION OF EXAMPLE EMBODIMENTS

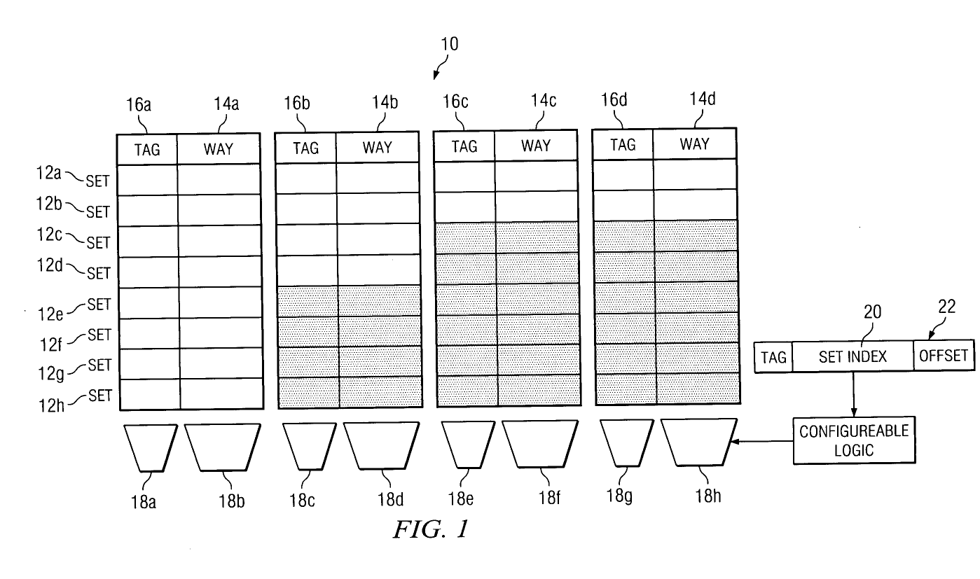

FIG. 1 illustrates an example nonuniform cache architecture for reducing power consumption at a cache 10. In particular embodiments, cache 10 is a component of a processor used for temporarily storing code for execution at the processor. Reference to “code” encompasses one or more executable instructions, other code, or both, where appropriate. Cache 10 includes multiple sets 12, multiple ways 14, and multiple tags 16. A set 12 logically intersects multiple ways 14 and multiple tags 16. A logical intersection between a set 12 and a way 14 includes multiple memory cells adjacent each other in cache 10 for storing code. A logical intersection between a set 12 and a tag 16 includes one or more memory cells adjacent each other in cache 10 for storing data facilitating location of code stored in cache 10, identification of code stored in cache 10, or both. As an example and not by way of limitation, a first logical intersection between set 12a and tag 16a may include one or more memory cells for storing data facilitating location of code stored at a second logical intersection between set 12a and way 14a, identification of code stored at the second logical intersection, or both. Cache 10 also includes multiple sense amplifiers 18. In particular embodiments, sense amplifiers 18 are used to read contents of memory cells in cache 10. Although a particular cache 10 including particular components arranged according to a particular organization is illustrated and described, the present invention contemplates any suitable cache 10 including any suitable components arranged according to any suitable organization. Moreover, the present invention is not limited to a cache 10, but contemplates any suitable memory system.

In particular embodiments, a nonuniform architecture in cache 10 reduces power consumption at cache 10, current leakage from cache 10, or both. A nonuniform architecture allows sets 12 to have associativity values that are different from each other. In particular embodiments, a first set 12 has an associativity value different from a second set 12 if first set 12 intersects a first number of active ways 14, second set 12 intersects a second number of active ways 14, and the first number is different from the second number. As an example and not by way of limitation, according to a nonuniform architecture in cache 10, way 14a, way 14b, way 14c, and way 14d are all active in set 12a and set 12b; only way 14a and way 14b are active in set 12c and set 12d; and only way 14a is active in set 12e, set 12f, set 12g, and set 12h. In particular embodiments, an active memory cell is useable for storage and an inactive memory cell is unuseable for storage.

In particular embodiments, an optimum number of cache ways in each cache set is determined during design of a cache 10. As an example and not by way of limitation, a hardware, software, or embedded logic component or a combination of two or more such components may execute an algorithm for determining an optimum number of cache ways in each cache set, as described below. One or more users may use one or more computer systems to provide input to and receive output from the one or more components. Reference to a “cache way” encompasses a way 14 in a cache 10, where appropriate. Reference to a “cache set” encompasses a set 12 in a cache 10, where appropriate. In particular embodiments, the number of active cache ways in cache 10 may be changed dynamically while an application program is running. In particular embodiments, one or more sleep transistors are useable to dynamically change the number of active cache ways in cache 10. In particular embodiments, a power supply to unused cache ways may be disconnected from the unused cache ways by eliminating vias used for connecting the power supply to memory cells in the unused cache ways. Unused memory cells may also be disconnected from bit and word lines in the same fashion.

In particular embodiments, a second valid bit may be used to mark an unused cache block. Reference to a “cache block” encompasses a logical intersection between a set 12 and a way 14, where appropriate. The cache block also includes a logical intersection between set 12 and a tag 16 corresponding to way 14, where appropriate. In particular embodiments, one or more valid bits are appended to each tag 16 in each set 12. In particular embodiments, such bits are part of each tag 16 in each set 12. If the second valid bit is 1, the corresponding cache block is not used for replacement if a cache miss occurs. Accessing an inactive cache block causes a cache miss. In particular embodiments, to reduce power consumption at nonuniform cache 10, sense amplifiers 18 of cache ways marked inactive in a cache set targeted for access are deactivated. In particular embodiments, this is implemented by checking a set index 20 of a memory address register 22. As an example and not by way of limitation, in nonuniform cache 10 illustrated in FIG. 1, sense amplifier 18c and sense amplifier 18d may be deactivated when set 12e, set 12f, set 12g, or set 12h is targeted for access. Sense amplifier 18e, sense amplifier 18f, sense amplifier 18g, and sense amplifier 18h may all be deactivated when set 12c, set 12d, set 12e, set 12f, set 12g, or set 12h is targeted for access.

Tag access and tag comparison need not be performed for all instruction fetches. Consider an instruction j executed immediately after an instruction i. There are three cases:

1. Intra Cache-Line Sequential Flow
This occurs when both i and j instructions reside on the same cache-line, and i is a non-branch instruction or an untaken branch.

2. Inter Cache-Line Sequential Flow
This case is similar to the first one, the only difference is that i and j reside on different cache-lines.

3. Nonsequentialflow
In this case, i is a taken branch instruction and j is its target.

In the first case, intra cache-line sequential flow, it is readily detectable that j and i reside in the same cache way. Therefore, a tag lookup for instruction j is unnecessary. On the other hand, a tag lookup and a way access are required for a nonsequential fetch, such as for example a taken branch (or nonsequential flow) or a sequential fetch across a cache-line boundary (or inter cache-line sequential flow). As a consequence, deactivating memory cells of tags 16 and ways 14 in cases of intra cache-line sequential flow reduces power consumption at cache 10. Particular embodiments use this or a similar inter line way memorization (ILWM) technique.

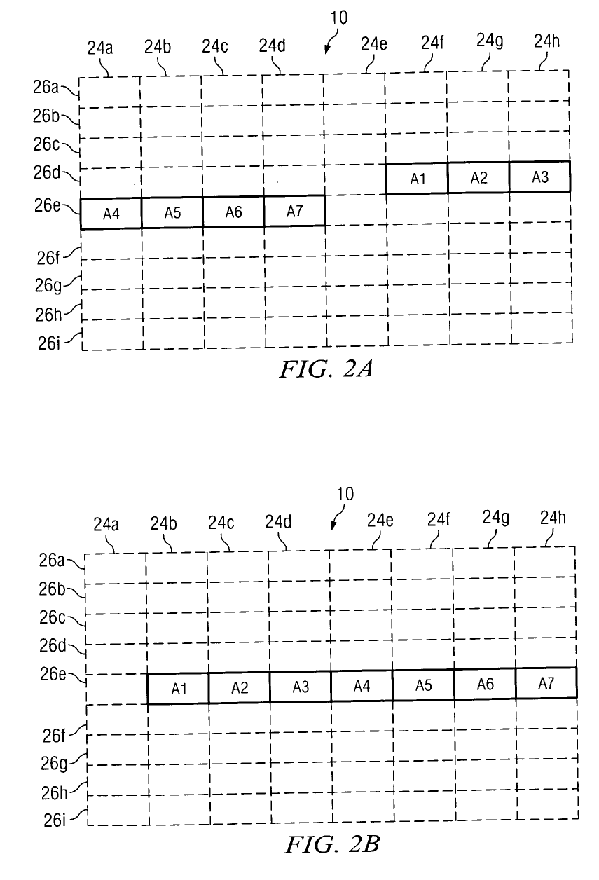

FIGS. 2A and 2B illustrate example code placement for reducing power consumption at a cache 10. Consider a basic block of seven instructions. The basic block is designated A, and the instructions are designated A1, A2, A3, A4, A5, A6, and A7. A7 is a taken branch, and A3 is not a branch instruction. In FIG. 2A, A7 resides at word 24d of cache line 26e. A3 resides at word 24h of cache line 26d. A tag lookup is required when A3 or A7 is executed because, in each case, it is unclear whether a next instruction resides in cache 10. However, in FIG. 2B, A is located in an address space of cache 10 so that A does not span any cache-line boundaries. Because A does not span any cache-line boundaries, a cache access and a tag access may be eliminated for A3. In particular embodiments, the placement of basic blocks in main memory is changed so that frequently accessed basic blocks do not span any cache-line boundaries (or span as few cache-line boundaries as possible) when loaded into cache 10 from main memory.

Decreasing the number of occurrences of inter cache-line sequential flows reduces power consumption at cache 10. While increasing cache-line size tends to decrease such occurrences, increasing cache-line size also tends to increase the number of off-chip memory accesses associated with cache misses. Particular embodiments use an algorithm that takes this trade-off into account and explores different cache-line sizes to minimize total power consumption of the memory hierarchy.

Consider a direct-mapped cache 10 of size C (where C=2^{m} words) having a cache-line size of L words. L consecutive words are fetched from the memory on a cache-read miss. In a direct-mapped cache 10, the cache line containing a word located at memory address M may be calculated by

$$( ⌊ \frac{M}{L} ⌋ mod \frac{C}{L} ) .$$

Therefore, two memory locations Mᵢ and Mⱼ will map to the same cache line if the following condition holds:

$$( ⌊ \frac{{M}_{i}}{L} ⌋ - ⌊ \frac{{M}_{j}}{L} ⌋ ) mod \frac{C}{L} = 0$$

The above equation may be written as:
(n·C−L)<(Mᵢ−Mⱼ)<(n·C+L) (1)
where n is any integer. If basic blocks Bᵢ and Bⱼ are inside a loop having an iteration count of N and their memory locations Mᵢ and Mⱼ satisfy condition (1), cache conflict misses occur at least N times when executing the loop. This may be extended for a W-way set associative cache 10. A cache conflict miss occurs in a W-way set associative cache 10 if more than W different addresses with distinct └M/L┘ values that satisfy condition (1) are accessed in a loop. M is the memory address. Therefore, the number of cache conflict misses can be easily calculated from cache parameters, such as, for example, cache-line size, the number of cache sets, the number of cache ways, the location of each basic block in the memory address space of cache 10, and the iteration count for each closed loop for a target application program. Particular embodiments optimize cache configuration and code placement more or less simultaneously to reduce dynamic and leakage power consumption at cache 10 and off-chip memory for a given performance constraint. In particular embodiments, an algorithm calculates the number of cache conflicts in each cache set for a given associativity.

The following notation may be used to provide an example problem definition for code placement:
E_{memory}, E_{way}, and E_{tag}: The energy consumption per access for the main memory, a single cache way, and a cache-tag memory, respectively.
P_{static}: The static power consumption of the main memory.
TE_{memory} and TE_{cache}: The total energy consumption of the main memory, e.g., the off-chip memory, and cache 10, respectively.
P_{leakage}: The leakage power consumption of a 1-byte cache memory block.
TE_{leakage}: The total energy consumption of the cache memory due to leakage.
W_{bus}: The memory access bus width (in bytes).
Wᵢₙₛₜ: The size of an instruction (in bytes).
S_{cache}: The number of sets in a cache memory.
C_{access}: The number of CPU cycles required for a single memory access.
C_{wait}: The number of wait-cycles for a memory access.
F_{clock}: The clock frequency of CPU.
nₗᵢₙₑ: The line size of the cache memory (in bytes).
aᵢ: The number of ways in the i^{th} cache set.
Nₘᵢₛₛ: The number of cache misses.
Nᵢₙₛₜ: The number of instructions executed.
Xᵢ: The number of “full-way accesses” for the i^{th} cache set. In the “full-way” access all cache ways and cache-tags in the target cache set are activated. A “full-way access” is necessary in case of an inter-cache-line sequential flow or a non-sequential flow. Otherwise, only a single cache way is activated.
Tₜₒₜₐₗ, and T_{const}: The total execution time and the constraint on it.
Pₜₒₜₐₗ: The total power consumption of the memory system.

Assume E_{memory}, E_{way}, E_{tag}, P_{static}, P_{leakage}, W_{bus}, Wᵢₙₛₜ, S_{cache}, F_{clock}, C_{access}, C_{wait}, and T_{const} are given parameters. The parameters to be determined are nₗᵢₙₑ and aᵢ. Nₘᵢₛₛ, Xᵢ, and Tₜₒₜₐₗ are functions of the code placement, W_{bus}, Wᵢₙₛₜ, nₗᵢₙₑ, and aᵢ. Nₘᵢₛₛ, Nᵢₙₛₜ, and Xᵢ may be found according to one or more previous methods. Since a cache 10 is usually divided into sub-banks and only a single sub-bank is activated per access, E_{way} is independent of nₗᵢₙₑₛ.

The following example problem definition may be used for code placement: for given values of E_{memory}, E_{way}, E_{tag}, P_{static}, P_{leakage}, W_{bus}, Wᵢₙₛₜ, S_{cache}, F_{clock}, C_{access}, C_{wait}, and the original object code, determine code placement, nₗᵢₙₑ and aᵢ to minimize Pₜₒₜₐₗ, the total power consumption of the memory hierarchy under the given time constraint T_{const}. Tₜₒₜₐₗ, TE_{memory}, TE_{cache}, TE_{leakage}, and Pₜₒₜₐₗ may be calculated using the following formulas:

$${T}_{total} = \frac{1}{{F}_{clock}} \cdot \{ {N}_{inst} + {N}_{miss} \cdot ( {C}_{access} \cdot \frac{{n}_{line}}{{W}_{bus}} + {C}_{wait} ) \}$$

$${TE}_{memory} = {E}_{memory} \cdot {N}_{miss} \cdot \frac{{n}_{line}}{{W}_{bus}} + {P}_{static} \cdot {T}_{total}$$

$${TE}_{cache} = {E}_{way} \cdot {N}_{inst} + {E}_{way} \cdot {N}_{miss} \cdot \frac{{n}_{line}}{{W}_{inst}} + {E}_{tag} \cdot {N}_{miss} + {E}_{way} \cdot {\sum }_{i = 0}^{{S}_{cache}} \{ ( {a}_{i} - 1 ) \cdot {X}_{i} \} + {E}_{tag} \cdot {\sum }_{i = 0}^{{S}_{cache}} ( {a}_{i} - {X}_{i} )$$

$${TE}_{leakage} = {P}_{leakage} \cdot {T}_{total} \cdot {n}_{line} \cdot {\sum }_{i = 0}^{{S}_{cache}} {a}_{i}$$

$${P}_{total} = \frac{( {TE}_{memory} + {TE}_{cache} + {TE}_{leakage} )}{{T}_{total}} , {T}_{total} \leq {T}_{const}$$

In particular embodiments, an algorithm starts with an original cache configuration (nₗᵢₙₑₛ=32, S_{cache}=8, aᵢ=64). In the next step, the algorithm finds the optimal location of each block of the application program in the address space. In particular embodiments, this is done by changing the order of placing functions in the address space and finding the best ordering. For each ordering, the algorithm greedily reduces the energy by iteratively finding a cache set for which reducing the number of cache ways by a factor of two gives the largest power reduction. The power consumption (Pₜₒₜₐₗ) and the run-time (Tₜₒₜₐₗ) are found by calculating the number of cache misses for a given associativity. The calculation may be done without simulating cache 10 and by analyzing an iteration count of each loop and the location of each basic block in the address space for the application program. The ordering which gives the minimum energy is selected along with the optimal number of cache ways for each cache set. The algorithm performs the above steps for different cache-line sizes and continues as long as the power consumption reduces. The ordering of functions may be fixed when the cache-line sizes are changed. This is a good simplification because the optimum ordering of functions usually does not change widely when cache-line sizes vary by a factor of two. In particular embodiments, the computation time of the algorithm is quadratic in terms of the number of functions and linear in terms of the number of loops of the application program.

By way of example and not by way of limitation, the following pseudocode embodies one or more example elements of the algorithm described above:

Procedure MinimizePower

| Input: | E_{memory}, E_{way}, E_{tag}, P_{leakage}, W_{bus}, Wᵢₙₛₜ, S_{cache}, |
|---|---|
| | F_{clock}, C_{access}, C_{wait}, T_{count}, P_{static}, and original |
| | object code. |
| Output: | nₗᵢₙₑ, a set of aᵢ, and order of functions in the |
| | optimized object code |

Let L be the list of functions in the target program sorted in
descending order of their execution counts;

Pₘᵢₙ = Tₘᵢₙ = infinity;
for each nₗᵢₙₑ ε {32,64,128,256,512} do

| | |
|---|---|
| Pᵢₙᵢₜ = Pₘᵢₙ; | Tᵢₙᵢₜ = Tₘᵢₙ, |
| repeat | |

Pₘᵢₙ = P_{init,,} Tₘᵢₙ = Tᵢₙᵢₜ
for (t=0; t<| L| ;t++) do

p = L[t];
for each p′ε L and p′≠ p do

Insert function p in the place of p′;
Set all aᵢ to 64 and calculate Pₜₒₜₐₗ and Tₜₒₜₐₗ;
repeat

| 1. | Find a cache-set for which |
|---|---|
| | reducing the number of cache |
| | ways by a factor of 2 |
| | results in the largest power |
| | reduction; |
| 2. | Divide the number of cache- |

ways for the cache-set by
2 and calculate Pₜₒₜₐₗ and
Tₜₒₜₐₗ;

until ((Pₜₒₜₐₗ stops decreasing) or (Tₜₒₜₐₗ>
T_{const}))
if (Pₜₒₜₐₗ ≦ Pₘᵢₙ & Tₜₒₜₐₗ ≦ Tₘᵢₙ) then

Pₘᵢₙ = Pₜₒₜₐₗ; Tₘᵢₙ = Tₜₒₜₐₗ; BEST_{location}
= p′;

end if

end for
Put function p in the place of BEST_{location}

end for

until (Pₘᵢₙ stops decreasing)
if (Pᵢₙᵢₜ = Pₘᵢₙ & Tᵢₙᵢₜ ≦ T_{const}) then

| | |
|---|---|
| Output BESTₗᵢₙₑ, BEST_{ways} and BEST_{order}; | Exit; |

else

| | |
|---|---|
| BESTₗᵢₙₑ = nₗᵢₙₑ; | BEST_{ways} = a set of aᵢ, |

BEST_{order} = order of functions;

end if

end for

end Procedure

In particular embodiments, a hardware, software, or embedded logic component or a combination of two or more such components execute one or more steps of the algorithm above. One or more users may use one or more computer systems to provide input to and receive output from the one or more components.

Particular embodiments have been used to describe the present invention. A person having skill in the art may comprehend one or more changes, substitutions, variations, alterations, or modifications to the particular embodiments used to describe the present invention that are within the scope of the appended claims. The present invention encompasses all such changes, substitutions, variations, alterations, and modifications.

What is claimed is:

1. A method for reducing power consumption at a cache, the method comprising:
determining a code placement according to which code is writable to a memory separate from a cache, the code placement reducing occurrences of inter cache-line sequential flows when the code is loaded from the memory to the cache; and
compiling the code according to the code placement; and
writing the code to the memory for subsequent loading from the memory to the cache according to the code placement to reduce power consumption at the cache.

2. The method of claim 1, further comprising:
determining a nonuniform architecture for the cache providing an optimum number of cache ways for each cache set in the cache, the nonuniform architecture allowing cache sets in the cache to have associativity values that differ from each other; and
implementing the nonuniform architecture in the cache to further reduce power consumption at the cache.

3. The method of claim 1, wherein the cache is an instruction cache on a processor.

4. The method of claim 1, wherein the memory separate from the cache comprises a main memory associated with a processor.

5. The method of claim 1, wherein an inter cache-line sequential flow comprises a basic block spanning a cache-line boundary in the cache.

6. The method of claim 1, wherein:
reducing the occurrences of inter cache-line sequential flows reduces tag look ups during execution of the code; and
reducing the tag look ups during execution of the code facilitates the reduction of power consumption at the cache.

7. Logic for reducing power consumption at a cache, the logic encoded in one or more media and when executed operable to:
determine a code placement according to which code is writeable to a memory separate from a cache, the code placement reducing occurrences of inter cache-line sequential flows when the code is loaded from the memory to the cache; and
compile the code according to the code placement for writing to the memory for subsequent loading from the memory to the cache according to the code placement to reduce power consumption at the cache.

8. The logic of claim 7, further operable to:
determine a nonuniform architecture for the cache providing an optimum number of cache ways for each cache set in the cache, the nonuniform architecture allowing cache sets in the cache to have associativity values that differ from each other; and
implement the nonuniform architecture in the cache to further reduce power consumption at the cache.

9. The logic of claim 7, wherein the cache is an instruction cache on a processor.

10. The logic of claim 7, wherein the memory separate from the cache comprises a main memory associated with a processor.

11. The logic of claim 7, wherein an inter cache-line sequential flow comprises a basic block spanning a cache-line boundary in the cache.

12. The logic of claim 7, wherein:
reducing the occurrences of inter cache-line sequential flows reduces tag look ups during execution of the code; and
reducing the tag look ups during execution of the code facilitates the reduction of power consumption at the cache.

13. A system for reducing power consumption at a cache, the system comprising:
a memory; and
code having been compiled and written to the memory according to a code placement reducing occurrences of inter cache-line sequential flows when the code is loaded from the memory to a cache separate from the memory, the code being loadable from the memory to the cache according to the code placement to reduce power consumption at the cache.

14. The system of claim 13, further comprising a nonuniform architecture implemented in the cache to further reduce power consumption at the cache, the nonuniform architecture providing an optimum number of cache ways for each cache set in the cache and allowing cache sets in the cache to have associativity values that differ from each other.

15. The system of claim 13, wherein the cache is an instruction cache on a processor.

16. The system of claim 13, wherein the memory separate from the cache comprises a main memory associated with a processor.

17. The system of claim 13, wherein an inter cache-line sequential flow comprises a basic block spanning a cache-line boundary in the cache.

18. The system of claim 13, wherein:
reducing the occurrences of inter cache-line sequential flows reduces tag look ups during execution of the code; and
reducing the tag look ups during execution of the code facilitates the reduction of power consumption at the cache.

19. A system for reducing power consumption at a cache, the system comprising:
means for determining a code placement according to which code is writeable to a memory separate from a cache, the code placement reducing occurrences of inter cache-line sequential flows when the code is loaded from the memory to the cache; and
means for compiling the code according to the code placement for writing to the memory for subsequent loading from the memory to the cache according to the code placement to reduce power consumption at the cache.
